(19) United States
(12) Patent Application Publication
(10) Pub. No.: US 2009/0167995 A1
(43) Pub. Date: Jul. 2, 2009

(54) LCD WITH IMPROVED CONTRAST RATIO AND APPARATUS UTILIZING THE SAME

(75) Inventors: Gerben Johan Hekstra, Waalre (NL); Nathalie Magali Danielle Dessaud, Eindhoven (NL)

Correspondence Address: LOWE HAUPTMAN HAM & BERNER, LLP, 1700 DIAGONAL ROAD, SUITE 300, ALEXANDRIA, VA, 22314, US

(73) Assignee: TPO Displays Corp., Chu-Nan (TW)

(21) Appl. No.: 12/334,302

(22) Filed: Dec. 12, 2008

Related U.S. Application Data
(60) Provisional application No. 61/017,170, filed on Dec. 27, 2007.

(30) Foreign Application Priority Data
Sep. 18, 2008 (EP) 08164707.5

(51) Int. Cl. G02F 1/1335

(52) U.S. Cl. 349/96

(57) ABSTRACT

An LCD device with an LCD cell. The cell has a liquid crystal layer, a base panel adjacent to the liquid crystal layer and a top panel adjacent to the liquid crystal layer but opposing the base panel. The base panel has a first polarizer arranged to polarize incident light into a first direction. The top panel has a color filter with one or more color filter portions so as to produce light with a predetermined color, a second polarizer on a side of the color filter opposite to the liquid crystal layer and designed to polarize incident light into a second direction perpendicular to the first direction, and a third polarizer located between the color filter and the liquid crystal layer and designed to polarize incident light into the second direction.

### CROSS REFERENCE TO RELATED APPLICATIONS

This application claims the benefit of U.S. Provisional Application No. 61/017,170 filed Dec. 27, 2007 and claims the priority of European Patent Application No. 08164707.5, filed on Sep. 18, 2008, the entirety of which is incorporated by reference herein.

### BACKGROUND OF THE INVENTION

1. Field of the Invention

The present invention relates to LCD with improved contrast ratio and apparatus comprising such a LCD.

2. Description of the Related Art

A liquid crystal display (LCD) is one of the most widely used flat panel displays. An LCD includes two panels provided with field-generating electrodes such as pixel electrodes and a common electrode and a liquid crystal (LC) layer sandwiched between those panels. The LCD displays images by applying voltages to field-generating electrodes to generate an electric field in the LC layer, which determines orientations of LC molecules in the LC layer to adjust polarization of incident light.

The need to increase the color gamut of displays makes multi-primary displays interesting. One of the recent developments is a RGBY display which has a red (R), green (G), blue (B) and yellow (Y) color filter portion in the color filter of the LCD pixel. Such RGBY displays are interesting for color rendering since they have a wider color gamut than RGB or RGBW LCDs. Moreover, they have a lower power consumption than RGB LCDs.

The materials and processes of the red, green and blue color filter portions have been optimised to make sure the diffusion of light through the color filter is being reduced. Some depolarization occurs in the red, green and blue color filter portions but to an acceptable level.

However no yellow pigments are available to render a suitable yellow color filter portion. Nowadays, they show a substantial amount of diffusion which results in depolarization of incident polarized light. This reduces the contrast ratio (CR) and the color gamut drastically.

Still, RGBY or RGyGcB are among the most promising multi-primary displays to allow a good rendering of natural surface colors. For instance, Sanyo-Epson presented an RGyGcB display (ChromaRich technology) which showed improved color gamut. This display has been used in the Epson P-3000 and P-5000 line of photo viewers. However, tests have shown that the yellow color filter is still depolarising the light and therefore may be unacceptable for LCD applications.

It is observed that E. Peeters, e.a., disclose various materials that can be used for in-cell polarizers such as: polarizers based on lyotropic liquid crystalline dyes or in-situ photo-polymerization of highly ordered (smectic) guest-host systems. Such guest-host systems may be based on reactive liquid crystal diacrylates. Photo-polymerization may be obtained by doping such diacrylates with dichroic dye molecules, e.g., as present in dichroic azo dye. E. Petters, J. Lub, A. A. Stenbakkers and D. J. Broer, Advanced Materials, 2006, 18, 2412-2417. E. Petters, J. Lub, W P M Nijssen, J. Stenbakkers and D J. Broer, EuroDisplay 2005, 165-167. E. Peeters, e.a., disclose the idea to use such in-cell polarizers as a replacement for traditional polarizers on the outside of an LCD cell. They do not disclose or suggest to use such in-cell polarizers in addition to traditional outside polarizers.

### BRIEF SUMMARY OF THE INVENTION

An exemplary embodiment of a LCD device comprises at least one LCD cell. The LCD cell comprises a liquid crystal layer, a base panel, and a top panel. The base panel is adjacent to said liquid crystal layer and comprises a first polarizer arranged to polarize incident light into a first direction. The top panel is adjacent to said liquid crystal layer but opposing said base panel, and comprises a color filter, a second polarizer, and a third polarizer. The color filter comprises at least one color filter portions so as to produce light of a predetermined color. The second polarizer is arranged on a side of said color filter opposite to said liquid crystal layer and arranged to polarize incident light into a second direction perpendicular to said first direction. The third polarizer is arranged between said color filter and said liquid crystal layer and arranged to polarize incident light into the second direction.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a block diagram of a LCD device;

FIG. 2a exemplarily shows the profile of a LCD pixel cell;

FIG. 2b exemplarily shows the profile of components of a LCD pixel cell;

FIGS. 3a and 3b, respectively, schematically show one pixel (or cell) of a prior art color LCD device;

FIGS. 4a and 4b show embodiments of a pixel of an LCD device in accordance with the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

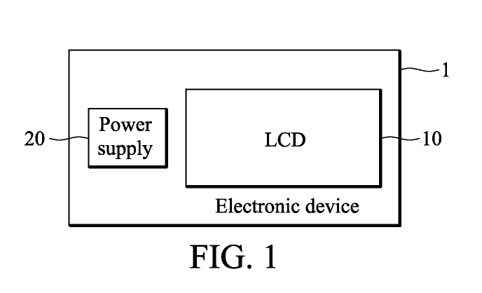

FIG. 1 is a diagram of an electronic device 1 with an LCD 10 according to an embodiment of the present invention. The electronic device 1 also has a power supply 20 connected to the LCD 10 to supply power to the LCD 10. In this embodiment, the LCD 10 is a color image display integrated into the electronic device 1. As known to those skilled in the art, the electronic device 1 can be a mobile phone, a personal digital assistant (PDA), a notebook computer, a desktop computer, a television, a car media player, a portable video player, digital camera, global positioning system (GPS), car navigation system, avionics display, etc.

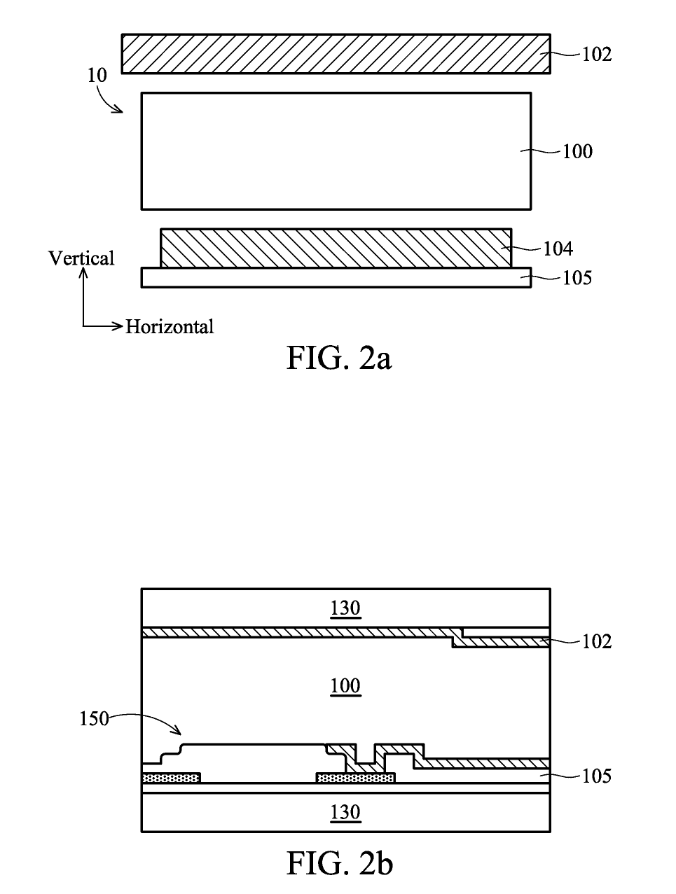

According to an embodiment of the present invention, FIG. 2a further illustrates the profile of LCD 10, which includes a liquid crystal (LC) layer 100, a common electrode 102, and a pixel electrode 104. The electrode 104 is arranged on a substrate 105. LCD 10 may have many cells, but FIG. 2a illustrates only one cell of LCD 10 to explain the present invention. In this example, the pixel cell, corresponding to a sub pixel, can have a size of 40 μm×40 μm and a thickness of 4.15 μm. Note that the pixel cell can have other sizes like 20 μm×20 μm, 30 μm×30 μm, 39.5 μm×39.5 μm, or 30 μm×61 μm (or other unsquare designs) and the thickness can be any suitable one greater than 1.5 μm. As shown, the LC layer 100, where the LC molecules are vertical aligned (not shown in FIG. 2a; “vertical” is to be understood in the orientation of the drawing shown in FIG. 2a), is sandwiched between the common electrode 102 and the pixel electrode 104. The electrode 104, placed on the TFT (TFT=thin film transistor, not shown) side, is provided for switching the liquid crystal layer 100. Note that the LCD 10 may include other components, such as substrates 130, color filters (not shown in FIG. 2b), and TFT (thin film transistors) 150, see FIG. 2b.

The common electrode 102, the LC layer 100, and the pixel electrode set 104 form a liquid crystal capacitor, which stores applied voltages after turn-off of the TFT(s) (not shown). The pixel electrode set 104, supplied with the data voltages, generates electric fields in cooperation with the common electrode 102, which reorients liquid crystal molecules of the liquid crystal layer 100. The common electrode 102, which can be a conventional common electrode, can be made of ITO or IZO. The pixel electrode 104 can be made of ITO or IZO too.

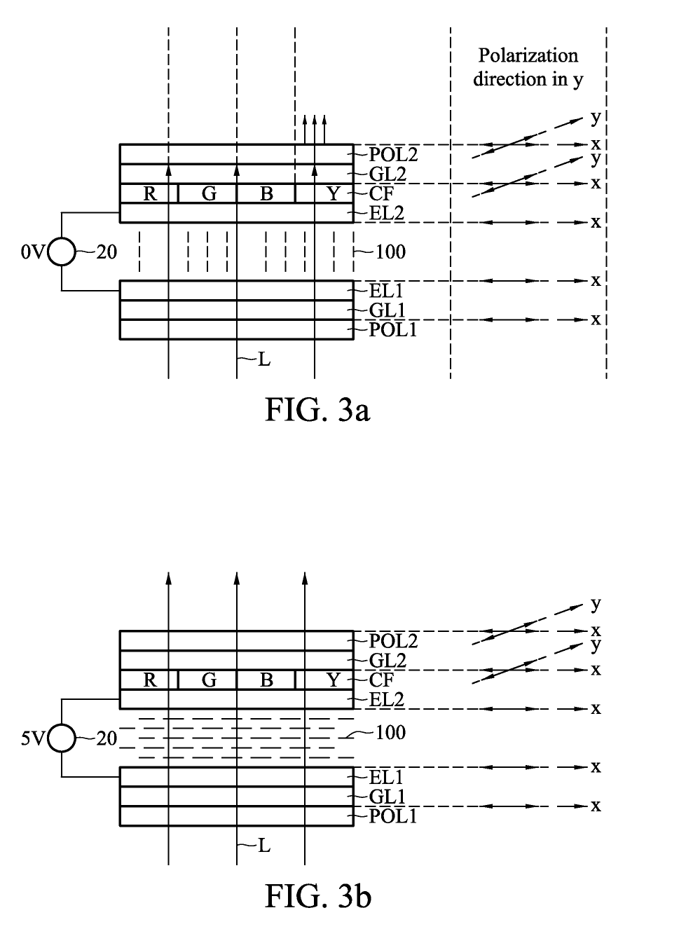

FIGS. 3a and 3b, respectively, schematically show one pixel (or cell) of a prior art color LCD device to further illustrate the problem to be solved by the present invention. FIG. 3a shows the pixel having a base panel with a polarizer POL1, a glass layer GL1 on top of the polarizer POL1 and an electrode EL1 on top of the glass layer GL1. Moreover, the pixel has a top panel with a polarizer POL2, a glass layer GL2 below the polarizer POL2, a color filter CF below the glass layer GL2 and an electrode EL2 below the color filter CF. Polarizer POL1 has a polarizing direction perpendicular to the polarizing direction of polarizer POL2. In the example shown, polarizer POL1 polarizes light in the x-direction and polarizer POL2 in the y-direction. The color filter CF, as shown in FIG. 3a, comprises 4 portions, i.e., a red portion R, a green portion G, a blue portion B and a yellow portion Y. It is observed that the terms “on top of” and “below” refer to the orientation as shown in the drawing and are not intended to limit the scope of the present invention.

The power supply 20 is connected between the electrode EL1 and electrode EL2. In the embodiment shown in FIG. 3a, the LCD device is of the so-called “vertical alignment” (VA) type, i.e., the molecules in the liquid crystal 100 are vertically aligned when the power supply voltage as provided by power supply 20 is low, e.g., 0 V. “Vertically” refers to a direction perpendicular to the surface of the electrodes EL1, EL2. In this state, the pixel should be “black”, i.e., should not be transparent for any light. It is observed that the technique of the invention is not restricted to VA but can also be applied for other LC modes, like FFS (Fringe Field Switching), IPS (In-Plane Switching), ECB (Electrically Controlled Birefringence), OCB (optically compensated bend).

FIG. 3a shows that light L falls on the bottom of the base panel. Light L falls on polarizer POL1 and becomes linearly polarized in the x-direction, as shown at the right hand side of the schematic pixel. The light L then passes glass layer GL1 and electrode EL1 and remains linearly polarized in the x-direction.

The light L then passes liquid crystal 100 unobstructed due to the molecules in liquid crystal 100 being vertically aligned. After having passed liquid crystal layer 100, the light L is still linearly polarized in the x-direction.

Then, the light L passes electrode EL2 and enters color filter CF. The portions of the light passing the red R, green G, and blue B portions, respectively, of the color filter CF are filtered to render a red, green, blue light portion, respectively. These three portions are still substantially linearly polarized in the x-direction because, nowadays, the materials used for these red R, green G, and blue B portions do not substantially alter the polarization.

However, materials used to date for the yellow portion Y are such that they diffuse passing light, resulting in a depolarizing effect. This is schematically shown at the right hand side of the pixel where, at the junction between yellow color filter portion Y and glass layer GL2, the polarization of the light having passed yellow color filter portion Y has both a x-component and a small y-component. I.e., there light L has become elliptically polarized.

All light L passes glass layer GL2 unaltered and arrives at the junction between glass layer GL2 and polarizer POL2. Polarizer POL2 blocks all light polarized in the x-direction. Therefore, all light that has passed the red R, green G, and blue B portions, respectively, will be completely blocked by polarizer POL2. I.e., downstream from these red R, green G, and blue B portions, respectively, the pixel is “black” (does not transmit any light). However, polarizer POL2 passes the y-component of the depolarized portion of light L that has passed yellow color filter portion Y. So, the pixel will transmit a small amount of (polarized) yellow light and will not appear entirely “black”. This is unacceptable for most applications.

FIG. 3b shows the same pixel as FIG. 3a. However, in the state shown in FIG. 3b, the power supply 20 now supplies a voltage sufficient to horizontally align the molecules in liquid crystal 100. This may, e.g., be 5 V. The effect of this horizontal alignment is that the direction of polarization of light L, which is polarized in the x-direction when it enters liquid crystal 100, is rotated by 90° (π/2). So when leaving liquid crystal 100 light L is polarized in the y-direction, as indicated at the right hand side of the pixel in FIG. 3b.

Again, the red R, green G, and blue B portions of color filter CF will substantially not alter the polarization direction of light L and will, thus, transmit red, green and blue light portions respectively all polarized in the y-direction. Polarizer POL2 will pass these red, green and blue light portions without altering them. Yellow color filter portion Y will, again, diffuse the light portion passing this portion resulting in some depolarization. Thus, the light having passed yellow portion Y will have a small component in the x-direction. However, most of the yellow light portion will be polarized in the y-direction. The latter portion will also pass polarizer POL2 without being altered. Only the yellow portion that is polarized in the x-direction will be obstructed by polarizer POL2. Still, most of the light will be transmitted by the pixel rendering the pixel a white color.

It will be understood by the person skilled in the art that, in reality, electrode EL 2 will be split in several electrode portions, i.e., one portion for each color filter portion R, G, B, Y. Each one of these electrode portions will be connected to a distinct TFT that is arranged to separately switch each one of these electrode portions on a separate voltage in order to switch each one of the color filter portions on and off by either vertically or horizontally aligning the molecules in the respective portions of the liquid crystal 100. The amount of light passed through the respective portions of the liquid crystal 100 can be controlled by controlling the voltage level applied to electrodes EL1 and EL2. Thus, the pixel can transmit any desired color.

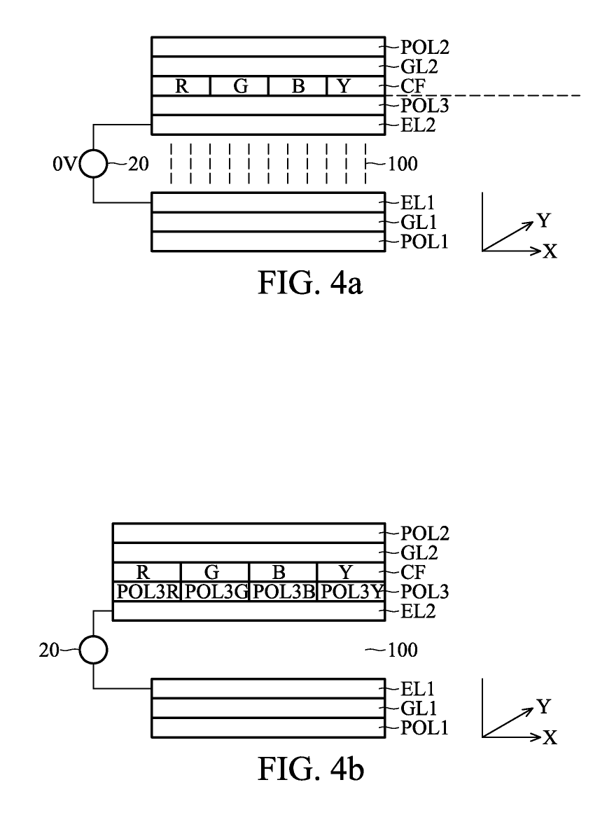

FIGS. 4a and 4b show embodiments of a pixel of an LCD device that solves the problem of insufficient black level, and therefore unacceptable contrast ratio.

Components of the pixel shown in FIGS. 4a and 4b that are the same as in FIGS. 3a and 3b are referenced with the same reference numbers. The difference between the pixel in FIGS. 4a, 4b and the pixel in FIGS. 3a, 3b is that the pixel in FIGS. 4a, 4b comprises an additional polarizer POL3 in the top panel upstream from the color filter CF. Such a polarizer is called an “in-cell polarizer”.

Ideally, additional polarizer POL3 should have the same polarizing direction as polarizer POL2. I.e, polarizer POL3 should only transmit light portions polarized in the y-direction and block the x-component of incident light completely. However, to date, in-cell polarizers having a 100% polarizing capacity in one direction are not yet known. So, in practice, some light polarized in the x-direction will still pass additional polarizer POL3.

In the embodiment shown in FIG. 4a, the additional polarizer POL3 is provided between electrode EL2 and color filter CF, and covers all color filter portions R, G, B, and Y.

The way the pixel of FIG. 4a operates is as follows. If power supply 20 provides an operating voltage of 0 V, all molecules in liquid crystal 100 are vertically aligned and liquid crystal 100 does not alter the passing light that is polarized in the x-direction. In that state, all light after having passed transparent electrode EL2 is at least partly blocked by additional polarizer POL3. The amount of light polarized in the x-direction and passing additional polarizer POL3 depends on the polarizing capacity of additional in-cell polarizer POL3. Some light polarized in the x-direction will still pass additional polarizer POL3. Portions of that remaining light passing the red R, green G, and blue B color filter portions will arrive at polarizer POL2 substantially without being altered as to their polarization direction. I.e., they are still polarized in the x-direction. Then, these remaining portions will be entirely blocked by polarizer POL2. However, the portion of the light entering the yellow color filter portion Y will, again, be diffused rendering a yellow, elliptically polarized light portion with both a yellow x-component and a yellow y-component. The yellow y-component will pass the polarizer POL2. So, still some amount of yellow light may be transmitted by the pixel. However, compared to the pixel of FIGS. 3a, 3b the contrast ratio is improved drastically.

In the on-state, the power supply 20 will provide a high voltage, e.g. 5 V which renders the molecules in liquid crystal 100 to become horizontally aligned. The effect of this horizontal alignment is that the direction of polarization of light L, which is polarized in the x-direction when it enters liquid crystal 100, is rotated by 90° (π/2). So when leaving liquid crystal 100 light L is polarized in the y-direction, As explained with reference to FIG. 3b, in this state, all light will not be obstructed when passing any of the color filter portions R, G, B, Y and polarizer POL2. However, also polarizer POL3 will not obstruct this light. So, in the on-state, pixel will show a white light.

Again, in practice, as will be understood by the person skilled in the art that, in the embodiment of FIG. 4a, electrode EL2 will be split in several electrode portions, i.e., one portion for each color filter portion R, G, B, Y. Each one of these electrode portions will be connected to a distinct TFT that is arranged to separately switch each one of these electrode portions on a separate voltage in order to switch each one of the color filter portions on and off by either vertically or horizontally aligning the molecules in the respective portions of the liquid crystal 100. The amount of light passing through the respective portions of the liquid crystal 100 can be controlled by controlling the voltage level applied to electrodes EL1 and EL2. Thus, the pixel can transmit any desired color.

Thus, the invention provides an LCD of which the pixels have an improved black level. However, also the white level is improved and therefore the LCD according to the invention increases the contrast ratio and the color gamut.

The embodiment shown in FIG. 4a has one polarizer POL3 below all four color filter portions R, G, B, Y. Such a single polarizer may be made of a broadband polarizer material, i.e., a material that is transparent for a broad frequency spectrum of the incident light L. Of course, such a broadband polarizer material should at least be transparent for the colors red, green, blue and yellow. Such materials could be selected from the group of materials comprising: polarizers based on lyotropic liquid crystalline dyes or in-situ photo-polymerization of highly ordered guest-host systems. Such guest-host systems may be smectic guest-host systems and may be based on reactive liquid crystal diacrylates. Photo-polymerization may be obtained by doping such diacrylates with dichroic dye molecules, e.g., as present in dichroic azo dye. More information about these materials can be obtained from E. Petters, J. Lub, A. A. Stenbakkers and D. J. Broer, Advanced Materials, 2006, 18, 2412-2417 and E. Petters, J. Lub, W P M Nijssen, J. Stenbakkers and D J. Broer, EuroDisplay 2005, 165-167.

In an alternative embodiment, the polarizer POL3 is split into at least two portions per pixel, as shown in FIG. 4b. FIG. 4b shows an example where polarizer POL3 has been split into four different portions: a portion POL3R, a portion POL3G, a portion POL3B, and a portion POL3Y. Each one of these polarizer portions POL3R, POL3G, POL3B, POL3Y is designed as a limited bandwidth polarizer. I.e., polarizer portion POL3R is designed to substantially transmit only light in the red frequency range. Polarizer portion POL3G is designed to substantially transmit only light in the green frequency range. Polarizer portion POL3B is designed to substantially transmit only light in the blue frequency range. Polarizer portion POL3Y is designed to substantially transmit only light in the yellow frequency range.

By the arrangement shown in FIG. 4b, each color filter portion will transmit light with a more limited bandwidth. This attributes to a better color gamut.

Instead of providing a separate polarizer portion POL3R, POL3G, POL3B, POL3Y for each one of the color filter portions R, G, B, Y, alternatively, two or three such separate polarizer portions may be provided. For instance, the polarizer portions POL3R, POL3G, POL3B may be one single portion made of a material being transparent to a broadband frequency spectrum including red, green and blue. However, other combinations are possible, depending on the available materials which may, for instance, be selected on ease of patterning into the proper configuration.

In the above embodiments, the polarizer POL3 has been shown to be located between the electrode EL2 and the glass layer GL2. However, alternatively, the polarizer POL3 may be located between the liquid crystal 100 and the electrode EL2.

The invention has been explained with reference to a R, G, B, Y LCD device but can equally be applied in any color LCD device using color filters. I.e., the invention as described here focuses on a yellow color filter, but the idea of making use of in-cell polarizers for any wavelength could also be of interest to traditional RGB (high contrast) displays or RGBX displays, where “X” means, e.g., Y=yellow, W=white, or any other color of the fourth color filter.

The LCD device according to the invention can be applied in mobile phones, personal digital assistants (PDA), notebook computers, desktop computers, televisions, car media players, portable video players, digital cameras, global positioning systems (GPS) as used in car navigation systems, avionics displays, etc. However, other applications may be true-color wide gamut displays, such as photo-viewers and photo-printer pre-viewers, where it is important that the gamut of the display matches the gamut of the photo paper, and that of the camera.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An LCD device, comprising:
at least one LCD cell comprising:
a liquid crystal layer;
a base panel adjacent to said liquid crystal layer and comprising a first polarizer arranged to polarize incident light into a first direction; and
a top panel adjacent to said liquid crystal layer but opposing said base panel, and comprising:
a color filter comprising at least one color filter portions so as to produce light of a predetermined color;
a second polarizer arranged on a side of said color filter opposite to said liquid crystal layer and arranged to polarize incident light into a second direction perpendicular to said first direction; and
a third polarizer arranged between said color filter and said liquid crystal layer and arranged to polarize incident light into the second direction.

2. The LCD device as claimed in claim 1, wherein said color filter comprises four color filter portions so as to produce substantially white light.

3. The LCD device as claimed in claim 1, wherein said third polarizer comprises at least two polarizer portions, each one of said at least two polarizer portions being arranged to polarize incident light for a distinct set of one or more of said color filter portions.

4. The LCD device as claimed in claim 3, wherein said color filter comprises four color filter portions and said third polarizer comprises four polarizer portions, each one of said four polarizer portions being arranged to polarize incident light for a distinct one of said four color filter portions.

5. The LCD device as claimed in claim 1, wherein said top panel comprises an electrode, said third polarizer being located between said electrode and said color filter.

6. The LCD device as claimed in claim 1, wherein said top panel comprises an electrode, said third polarizer being located between said electrode and said liquid crystal layer.

7. The LCD device as claimed in claim 1, wherein said third polarizer is selected from the group of materials comprising: polarizers based on lyotropic liquid crystalline dyes and polarizers based on in-situ photo-polymerization of guest-host systems.

8. The LCD device as claimed in claim 7, wherein said guest-host system is a smectic guest-host system.

9. The LCD device as claimed in claim 7, wherein said guest-host system is based on reactive liquid crystal diacrylates.

10. An apparatus comprising an LCD device as claimed in claim 1.

11. The apparatus as claimed in claim 10, wherein said apparatus is selected from the group comprising mobile phones, personal digital assistants (PDA), notebook computers, desktop computers, televisions, car media players, portable video players, digital cameras, car navigation systems, avionics displays, photo-viewers and photo-printer pre-viewers.

12. An electronic device, comprising:
an LCD as claimed in claim 1; and
a power supply connected to the LCD to supply power to the LCD.

13. The electronic device as claimed in claim 12, wherein said electronic device is selected from the group comprising mobile phones, personal digital assistants (PDA), notebook computers, desktop computers, televisions, car media players, portable video players, digital cameras, car navigation systems, avionics displays, photo-viewers and photo-printer pre-viewers.
